(19) United States
(12) Patent Application Publication
(10) Pub. No.: US 2008/0016079 A1
(43) Pub. Date: Jan. 17, 2008

(54) METHOD AND APPARATUS FOR LOCATING RADIO STATIONS

(75) Inventor: Jay D. Schroeder, Olathe, KS (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., George Town (KY)

(21) Appl. No.: 11/427,238

(22) Filed: Jun. 28, 2006

(51) Int. Cl. G06F 17/30; G06F 19/00

(52) U.S. Cl. 707/10; 701/200; 701/207; 707/1

(57) ABSTRACT

Embodiments of the present invention provide a navigation device (10) and method that are operable to locate a radio station utilizing a user's current geographic location. The navigation device (10) generally includes a location determining component (14) operable to determine a current geographic location of the device (10), a memory (16) operable to store data corresponding to radio stations and related geographic locations, a processor (12), and a display (20). The processor (12) is operable to identify at least one radio station utilizing the current geographic location of the device (10) and the display (20) is operable to present an indication of the identified radio station. Such a configuration enables accessible radio stations to be easily located without tedious and potentially dangerous manual scanning of radio frequencies.

### BACKGROUND OF THE INVENTION

1. Field of the Invention

The present invention relates to apparatuses and methods for locating radio stations. More particularly, the invention relates to a navigation device and method that are operable to locate radio stations utilizing a user's current geographic location.

2. Description of the Related Art

Radio station broadcasts have limited ranges due to the various limitations of electromagnetic wave propagation and Federal Communications Commission (FCC) rules and regulations. Consequently, users are unable to listen to their favorite radio stations when traveling significant distances from their homes. To locate new radio stations while traveling, users must manually scan the AM and FM frequency bands for desirable radio stations, such as radio stations having particular formats such as rock music or news. Manual scanning of frequency bands is often ineffective due to the number of available frequencies and the number of commercials likely to be encountered. Further, manual scanning of frequencies is often dangerous when preformed by automobile drivers, as is often the case when traveling. Thus, users are generally unable to easily identify local radio stations of interest.

### SUMMARY OF THE INVENTION

The present invention solves the above-described problems and provides a distinct advance in the art of locating radio stations. More particularly, the invention provides a navigation device and method that are operable to locate radio stations utilizing a user's current geographic location. Such a configuration enables accessible radio stations to be easily located without tedious and potentially dangerous manual scanning of radio frequencies.

In one embodiment, the present invention provides a navigation device that includes a location determining component operable to determine a current geographic location of the device, a memory operable to store data corresponding to radio stations and related geographic locations, a processor, and a display. The processor is operable to identify at least one radio station utilizing the current geographic location of the device and the stored data and the display is operable to present an indication of the identified radio station.

In another embodiment, the navigation device includes a location determining component operable to determine a current geographic location of the device, a memory operable to store data corresponding to radio stations and related broadcast ranges and geographic locations, a user interface operable to receive a user input corresponding to a radio station format, a processor, and a display. The processor is operable to determine when the current geographic location of the device enters and exits the broadcast range of one or more radio stations, identify a plurality of radio stations operable to broadcast to the current geographic location of the device and the stored data and sort the identified radio stations according to their range from the current geographic location, and identify at least one radio station utilizing the user input, the current geographic location of the device, and the stored data. The display is operable to present an indication of one or more of the identified radio stations.

In another embodiment, the navigation device includes a location determining component operable to determine a current geographic location of the device, a communications element operable to retrieve data corresponding to radio stations and related geographic locations from an external source, a processor, and a display. The processor is operable to identify at least one radio station utilizing the current geographic location of the device and the retrieved data and the display is operable to present an indication of the identified radio station.

In another embodiment, the present invention provides a method of identifying a radio station. The method generally includes acquiring a current geographic location of a user, acquiring data corresponding to radio stations and related geographic locations and storing the acquired data in a memory, accessing the memory and identifying at least one radio station utilizing the current geographic location of the user and the stored data, and presenting an indication of the identified radio station.

Other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is a front view of a navigation device configured in accordance with various preferred embodiments of the present invention;

FIG. 2 is a block diagram of certain components of the navigation device of FIG. 1;

FIG. 3 is a block diagram showing three radio stations within a predetermined range from the navigation device of FIGS. 1-2;

FIG. 4 is schematic diagram of a Global Positioning System (GPS) that may be utilized by various embodiments of the present invention;

FIG. 5 is a flow chart showing some of the steps that may be performed by various embodiments of the present invention;

FIG. 6 is a sample screen display of the navigation device of FIGS. 1-2, the sample screen display showing a radio station listing;

FIG. 7 is a sample screen display of the navigation device of FIGS. 1-2, the sample screen display showing a first broadcast range alert;

FIG. 8 is a sample screen display of the navigation device of FIGS. 1-2, the sample screen display showing a second broadcast range alert;

FIG. 9 is a sample screen display of the navigation device of FIGS. 1-2, the sample screen display showing a radio station search menu; and

FIG. 10 is a block diagram showing the navigation device of FIGS. 1-2 coupled with a communications network.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

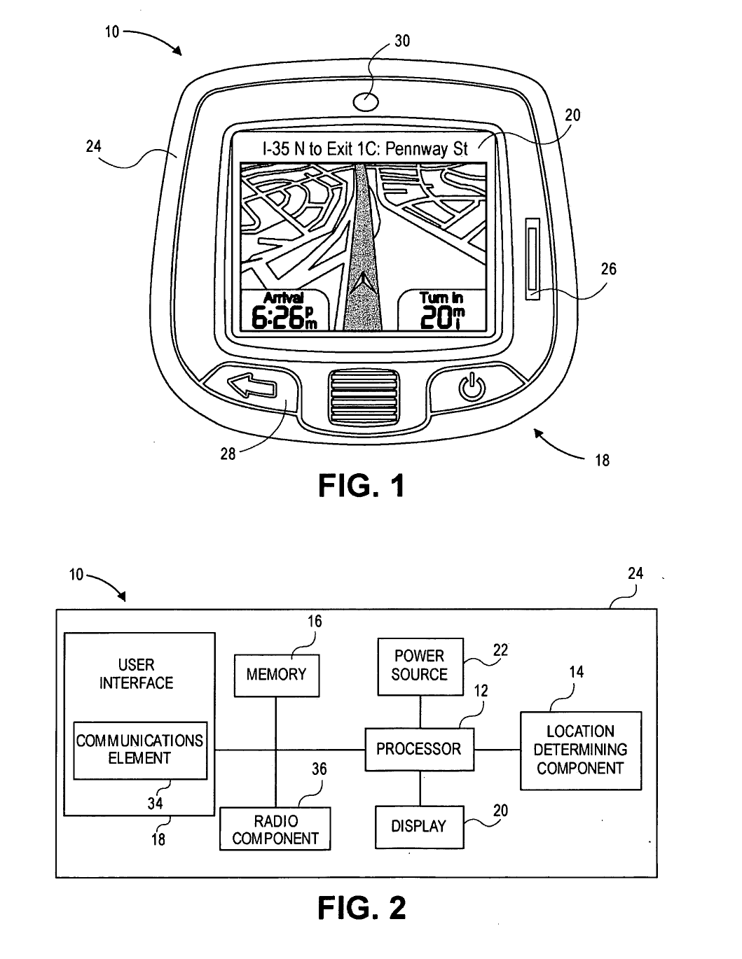

As shown in FIGS. 1-2, the present invention is preferably implemented utilizing an electronic device 10. The device 10 may be any electronic device operable to receive, utilize, or otherwise determine geographic information, such as a current geographic location. Thus, the device 10 may include computers, televisions, radios, portable computing devices such as laptops or personal data assistants (PDAs), cellular telephones, portable entertainment devices, etc. More preferably, the device 10 is a navigation device manufactured by GARMIN INTERNATIONAL, INC. of Olathe, Kans. However, the device 10 may be any device configured as described herein or otherwise operable to perform the functions described below.

The device 10 preferably includes a processor 12, a location determining component 14 coupled with the processor 12 to facilitate determination of a current geographic location, a memory 16 coupled with the processor 12 and operable to store information, a user interface 18 coupled with the processor 12 and operable to communicate with a user, a display 20 and power source 22 each coupled with the processor 12, and a housing 24 for housing the various components of the device 10.

The processor 12 is preferably coupled with the user interface 18, location determining component 14, memory 16, and display 20, through wired or wireless connections, such as a data bus, to enable information to be exchanged between the various elements. Further, the processor 12 is preferably operable to control the various functions of the device 10 according to a computer program, including one or more code segments, or other instructions associated with the memory 16 or with various processor logic and structure. The processor 12 may comprise various computing elements, such as integrated circuits, microcontrollers, microprocessors, programmable logic devices, etc, alone or in combination, to perform the operations described herein.

As described below in more detail, the processor 12 may determine a current geographic location of the device 10 by receiving the geographic location from the location determining component 14 or from another device through the user interface 18. Alternatively, the processor 12 may independently determine geographic locations based on information and/or data, such as received navigation signals, provided by the location determining component 14, stored within the memory 16, or acquired from other devices or elements.

The location determining component 14 is preferably a Global Positioning System (GPS) receiver, and is adapted to provide, in a substantially conventional manner, geographic location information for the device 10. The location determining component 14 may be, for example, a GPS receiver much like those disclosed in U.S. Pat. No. 6,434,485, which is incorporated herein by specific reference. However, the location determining component 14 may receive cellular or other positioning signals utilizing various methods to facilitate determination of geographic locations without being limited to GPS.

As is known in the art, the GPS is a satellite-based radio navigation system that allows determination of navigation information, such as position, velocity, time, and direction, for an unlimited number of users. Formally known as NAVSTAR, the GPS incorporates a plurality of satellites that orbit the earth.

The location determining component 14 scans for GPS satellite signals and, upon receiving signals from at least three different satellite signals, the location determining component 14 utilizes the three satellite signals to determine its own position. Acquiring a fourth satellite signal will allow the location determining component 14 to calculate its three-dimensional position by the same calculations. As should be appreciated, the processor 12 may be operable to perform one or more of these functions in place of the location determining component 14.

Although GPS enabled devices are often used to describe navigation devices, it will be appreciated that satellites need not be used to determine a geographic position of a receiving unit since any receiving device capable of receiving signals from multiple transmitting locations can perform basic triangulation calculations to determine the relative position of the receiving device with respect to the transmitting locations. For example, cellular towers or any customized transmitting radio frequency towers can be used instead of satellites. With such a configuration, any standard geometric triangulation algorithm can be used to determine the exact location of the receiving unit.

FIG. 4 shows one representative view of a GPS denoted generally by reference numeral 102. A plurality of satellites 104 are in orbit about the Earth 100. The orbit of each satellite is not necessarily synchronous with the orbits of other satellites and, in fact, is likely asynchronous. The navigation device 10, including the location determining component 14, is shown receiving spread spectrum GPS satellite signals from the various satellites 104.

The location determining component 14 may also include various processing and memory elements to determine the geographic location of the device 10 itself or it may provide information to the processor 12 to enable the processor 12 to specifically determine the geographic location of the device 10. Thus, the location determining component 14 need not itself calculate the current geographic location of the device 10 based upon received signals. The location determining component 14 also may include an antenna for receiving signals, such as a GPS patch antenna or helical antenna.

Further, the location determining component 14 may be integral with the processor 12 and/or memory 16 such that the location determining component 14 may be operable to specifically perform the various functions described herein. Thus, the processor 12 and location determining component 14 need not be separate or otherwise discrete elements.

In various embodiments the location determining component 14 need not directly determine the current geographic location of the device 10. For instance, the location determining component 14 may determine the current geographic location utilizing the user interface 18, such as by receiving location information from the user, through the communications network, from another electronic device, etc.

The memory 16 is coupled with the processor 12 and/or other device 10 elements and is operable to store various data utilized by the processor 12 and/or other elements. The memory 16 may include removable and non-removable memory elements such as RAM, ROM, flash, magnetic, optical, USB memory devices, and/or other conventional memory elements.

Further, the memory 16 may comprise a portion of the user interface 18 to enable the user to provide information to the device 10 via the memory 16, such as by inserting a removable memory element into a slot 26 to provide information and instruction to the device 10. The memory 16 may also be integral with the processor 12, such as in embodiments where the memory 16 comprises internal cache memory.

The memory 16 may store various data associated with operation of the device 10, such as a computer program, code segments, or other data for instructing the processor 12 and other device 10 elements to perform the steps described below. Further, the memory 16 may store various cartographic data corresponding to geographic locations including security locations, map data, and map elements, such as thoroughfares, terrain, alert locations, points of interest, geographic entities, radio stations, and other navigation data to facilitate the various navigation functions provided by the device 10. Additionally, the memory 16 may store destination addresses and previously calculated or otherwise acquired routes to various destination addresses for later retrieval by the processor 12.

Further, the various data stored within the memory 16 may be associated within a database to facilitate processor 12 retrieval of information. For example, the database may be configured to enable the processor 12 to retrieve geographic locations, geographic entities, and radio station information based upon a current geographic location of the device 10, as is discussed at length below.

The user interface 18 enables users, third parties, or other devices to share information with the device 10. The user interface 18 is generally associated with the housing 24, such as by physical connection through wires, etc, or wirelessly utilizing conventional wireless protocols. Thus, the user interface 18 need not be physically coupled with the housing 24.

The user interface 18 may comprise one or more functionable inputs 28 such as buttons, switches, scroll wheels, a touch screen associated with the display 20, voice recognition elements such as a microphone 30, pointing devices such as mice, touchpads, trackballs, styluses, a camera such as a digital or film still or video camera, combinations thereof, etc. Further, the user interface 18 may comprise wired or wireless data transfer elements such as removable memory including the memory 16, data transceivers, etc, to enable the user and other devices or parties to remotely interface with the device 10.

In some embodiments, the user interface 18 may include a communications element 34 to enable the device 10 to communicate with other computing devices 32, navigation devices, and any other network enabled devices through a communication network, such as the Internet, a local area network, a wide area network, an ad hoc or peer to peer network, or a direct connection such as a USB, Firewire, or Bluetooth connection, etc. Similarly, the user interface 18 may be configured to allow direct communication between similarly configured navigation devices, such that the device 10 need not necessarily utilize the communications network to share geographic location information.

In various embodiments the communications element 34 may enable the device 10 to wirelessly communicate with the communications network utilizing wireless data transfer methods such as WiFi (802.11), Wi-Max, Bluetooth, ultra-wideband, infrared, cellular telephony, radio frequency, etc. However, the communications element 34 may couple with the communications network utilizing wired connections, such as an Ethernet cable, and is not limited to wireless methods.

The user interface 18 is preferably operable to provide various information to the user utilizing the display 20 or other visual or audio elements such as a speaker. Thus, the user interface 18 enables the user and device 10 to exchange information relating to the device 10, including radio station information, geographic entities, configuration, security information, preferences, route information, points of interests, alerts and alert notification, navigation information, waypoints, a destination address, etc.

The display 20 is coupled with the processor 12 and/or other device 10 elements and is operable to display various information corresponding to the device 10, such as radio station information, maps, locations, and security information as is described below. The display 20 may comprise conventional black and white, monochrome, or color display elements including CRT, TFT, LCD, and/or plasma display devices. Preferably, the display 20 is of sufficient size to enable the user to easily view the display 20 to receive presented information while in transit.

Further, as described above, the display 20 may comprise a portion of the user interface 18, such as in embodiments where the display 20 is a touch-screen display to enable the user to interact with the display 20 by touching or pointing at display areas to provide information to the device 10.

The power source 22 is associated with the housing 24 to provide electrical power to various device 10 elements. For example, the power source 22 is preferably directly or indirectly coupled with the user interface 18, location determining component 14, processor 12, memory 16, and/or display 20. The power source 22 may comprise conventional power supply elements, such as batteries, battery packs, etc. The power source 22 may also comprise power conduits, connectors, and receptacles operable to receive batteries, battery connectors, or power cables. For example, the power source 22 may include both a battery to enable portable operation and a power input for receiving power from an external source such an automobile.

The housing 24 is preferably handheld or otherwise portable to facilitate transport of the device 10 between locations. In some embodiments, the housing 24 may be configured for mounting within or on an automobile or other vehicle in a generally conventional manner and may comprise generally conventional and durable materials, such as ABS, plastics, metals, etc, to protect the enclosed and associated elements.

In some embodiments, the device 10 may lack the location determining component 14 and portable housing 24 and be configured as a generally conventional computing element. Thus, in some embodiments the device 10 may comprise personal computers, desktop computers, servers, computing networks, personal digital assistants, laptops, cellular phones, portable entertainment and media devices, combinations thereof, etc., configured to perform one or more of the steps discussed below. For instance, the device 10 may comprise a server operable to execute a computer program or code segment to perform one or more of the below steps or portions thereof.

Preferably, the device 10 additionally includes a radio component 36 operable to receive radio frequency signals. The radio component 36 may be integral with the user interface 18, such as in embodiments where the radio component is integrated with the communications element to enable bi-directional radio frequency communication. However, the radio component 36 may be operable only to receive radio frequency signals.

The radio component 36 may be a generally conventional radio device operable to receive AM and FM radio signals and generate audio corresponding to the received signals. Thus, the radio component 36 may include conventional radio elements such as AM and FM antennas, analog and digital scanning and tuning elements, analog and digital amplification elements, displays, controls, speakers, etc.

Preferably, the radio component 36 is operable to receive and utilize radio data system (RDS) and/or radio data broadcast system (RDBS) signals. As utilized herein, “RDS signal” refers to both RDS and RDBS signals, as RDS and RDBS are often used interchangeably by those skilled in the art. RDS signals enable data, such as radio station names, station formats, song names, etc, to be transmitted in combination with a conventional FM signal. Thus, for example, the radio component 36 may be operable to receive a FM-RDS signal, generate an audible audio output corresponding to the received signal, such as music, and generate and/or display data correspond to the received RDS component, such as the name of the radio station broadcasting the signal. Further, the radio component 36 may also be able to receive RDS signals to acquire a radio station broadcast range, as is discussed in more detail below.

The radio component 36 may operate independently of the processor 12 and other device 10 elements, such that the radio component 36 is independently controlled and functioned by a user. However, in some embodiments the radio component 36 may be coupled with the processor 12 to enable the processor 12 to control and function the radio component 36. For example, the processor 12 may be able to function the radio component 36 to receive AM or FM signals at a particular frequency, scan for available signals, adjust the volume of outputted audio, store received FM-RDS information within the memory 16, etc.

The radio component 36 may be integral to the device 10 and be included in the housing 24, as shown in FIG. 2. Alternatively, the radio component 36 may be independent of the device 10, have its open separate housing, and/or be integral to a vehicle. For example, the radio component 36 may be similar to a conventional car stereo system. In this latter case, the processor 12 may communicate with the radio component 36 through a wired or wireless connection, such as USB, Bluetooth, Infrared, and/or the other systems described throughout the present specification. The processor 12 may alternatively communicate with the radio component 36 through a standard automotive bus, such as the OBD I, OBD II, and the like.

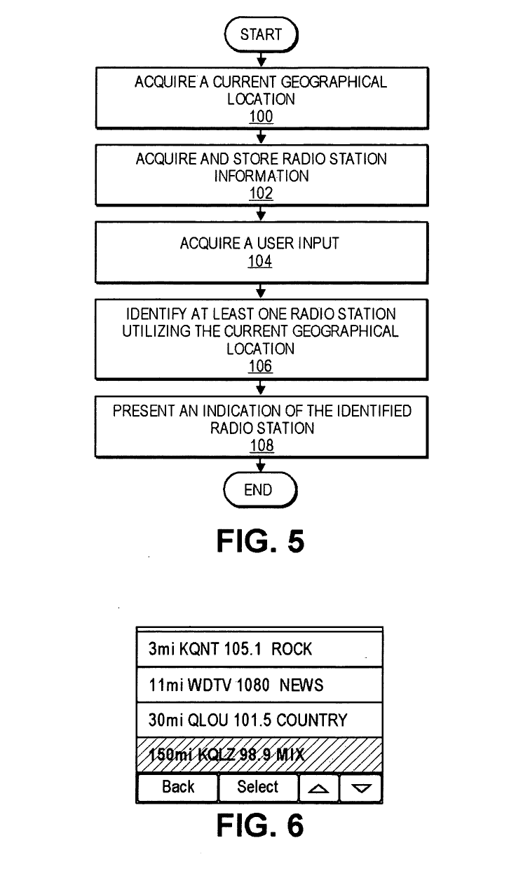

Steps 100-108 shown in FIG. 5 generally illustrate a method operable to be performed by various embodiments of the present invention. Steps 100-108 generally include: acquiring a current geographic location, referenced at step 100; acquiring radio station information, referenced at step 102; acquiring a user input, referenced at step 104; identifying a radio station, referenced at step 106; and presenting an indication of the identified radio station, referenced at step 108.

In step 100, the current geographic location is determined. Preferably, the determined current geographic location corresponds to the current geographic location of the device 10. However, in some embodiments the current geographic location may correspond to a user location independent of the device 10 location.

The current geographic location of the device 10 is preferably determined as described above utilizing the location determining component 14. Thus, for instance, the current geographic location may be determined in step 100 by receiving GPS signals and computing the current geographic location from the received GPS signals.

However, as is also described above, the current geographic location may be determined utilizing other methods, such as by retrieving the current geographic location from the memory 16, the user interface 18, and/or the communications network. For example, the current geographic location may be determined by allowing the user to select his or her location from a map or listing presented by the display 20.

In some embodiments, the current geographic location acquired in step 100 may correspond to a current geographic location of the user that may be determined and/or acquired independent of the device 10. Thus, for example, the user may provide his or her current geographic location through the communications network and/or directly input his or her current geographic location utilizing conventional methods.

In step 102, radio station information is acquired. The radio station information preferably includes data corresponding to radio stations and related geographic locations. For instance, the radio station information may include data corresponding to a plurality of radio stations including the name and/or call sign of each radio station, the category of each radio station (news, rock, weather, country, etc), the AM or FM frequency of each radio station, the geographic location of each radio station, the broadcast range of each radio station, combinations thereof, etc.

The radio station information may be acquired utilizing various methods. For instance, the user may function the user interface 18 to input radio station information, such as the name and geographic location of a radio station, for storage within the memory 16 and/or for utilization by the processor 12. However, the radio station information is preferably acquired without requiring the user to directly input all relevant data utilizing the user interface 18.

For example, the user may provide the device 10 with the radio station information by inserting a memory element into the slot 26. For example, a manufacturer or seller of the device 10 may provide the user with a memory element, such as a flash memory card, that includes the radio station information. The user may insert the memory element into the slot 26 to enable the device 10 to acquire the radio station information. In embodiments where the memory 16 and memory element are discrete, the processor 12 may transfer data corresponding to radio station information stored on the memory element to the memory 16.

Further, the device 10 may acquire the radio station information from an external source utilizing the communications element 34. For example, the processor 12 may instruct the communications element 34 to connect with an external source, such as one of the computing devices 32, through the communications network to retrieve radio station information therefrom. Thus, for instance, the processor 12 may acquire the radio station information from a web page, a file server, or from any other network accessible device or resource.

Similarly, the processor 12 may instruct the communications element 34 to connect with an external source directly, without relying on the communications network, to retrieve and store radio station information. For example, the device 10 and an external source, such as one of the computing devices 32, may be coupled with a USB cable or through direct wireless connection such as a Bluetooth connection, to transfer data corresponding to the radio station information from the computing device to the device 10.

In embodiments of the present invention that do not necessarily include the memory 16, or may include a smaller cache-type memory, the communications element 34 may be utilized to retrieve the radio station information from an external source through the communications network without storing data in the memory 16. For instance, the communications element 34 may dynamically retrieve radio station information for direct use by the processor 12 such that it is not necessary to store the retrieved information within the memory 16, for long periods of time and/or covering large geographical areas. Dynamic retrieval of radio station information ensures that the device 10 will be provided with accurate and reliable information as radio station formats, frequencies, and their locations, as well as the device's 10 current geographical location, changes.

Further, the radio component 36 may be utilized to acquire the radio station information from broadcasted radio signals. For example, radio stations may broadcast radio station information utilizing RDS signals and the radio component 36 may receive and decode the RDS signals to acquire the broadcast radio station information for use by the processor 12 and/or for storage within the memory 16. The RDS signals received by the radio component 36 may correspond to a particular radio station, such as the radio station broadcasting the RDS signals, or the received RDS signals may correspond to all radio stations within some range from the broadcast location of the RDS signals. For instance, the user could be instructed to tune the radio component 36 to a particular frequency that broadcasts RDS radio station information for all local radio stations.

In step 104, a user input is acquired. Preferably, the user input is acquired utilizing the user interface 18. For example, the user may depress or function one of the inputs 28 to provide the user input, the device 10 may receive the user input through the communications network utilizing the user interface 18, the processor 12 may retrieve the user input from the memory 16, the user may provide the user input utilizing the slot 26 and/or microphone 30, etc.

The acquired user input may be utilized by the device 10 in step 106 to identify a radio station. Consequently, the user input may correspond to any input that may facilitate radio station identification. For instance, the user input may correspond to: a desired radio station name, including call letters (e.g. KQNT) or an informal name (e.g. “the rock”); a desired radio station format, such as news, music, rock, country, weather, etc; a location or region, such as an address, zip code, city or state name, a map location, etc; a range from the current geographic location acquired in step 100; combinations thereof; etc.

In some embodiments, the device 10 may utilize the display 20 to provide a radio station search menu, such as the exemplary menu shown by FIG. 9. In embodiments having search menus, the user may provide one or more inputs corresponding to one or more radio station characteristics by functioning the user interface 18. Further, in some embodiments the user may be provided with a map, such as a map of the United States or a map of a specific region, and the user input may correspond to a selected portion of the displayed map.

In step 106, at least one radio station is identified utilizing the current geographic location acquired in step 100. Preferably, the device 10 identifies at least one radio station utilizing the current geographic location acquired in step 100 and the radio station information acquired in step 102.

For instance, the processor 12 may compare the current geographic location of the device 10 to the radio station geographic locations stored within the memory 16 or retrieved by the communications element 34 and determine the range between the device 10 and the radio stations. The processor 12 may identify the closest radio station, the radio stations having geographic locations within a predetermined range from the current geographic location, such as 100 or 150 miles, etc. Further, the processor 12 may identify various radio stations serving, covering, transmitting to, or otherwise utilizing the current geographic location of the device 10 and sort the identified radio stations according to their range from the current geographic location.

In embodiments where the acquired radio station information includes radio station broadcast ranges, the processor 12 may identify the radio stations that have broadcast ranges that include the current geographic location of the device 10. For instance, the processor 12 may compare the current geographic location of the device 10 with the radio station geographic locations and the corresponding broadcast ranges to determine which radio stations are within range of the device 10. The processor 12 may also order the identified radio stations according to their proximity to the device 10.

The processor 12 may look for radio stations within a certain range of the device. This is especially useful where processing power is limited and/or where radio station broadcast ranges are unavailable, or otherwise assumed to be constant. For example, the Federal Communications Commission (FCC) typically limits radio station broadcasts to a fixed transmission power, thereby effectively limiting the range of their broadcasts. Where that transmission power is constant across all radio stations in an area, the range of those radio stations is likely to be relatively constant too. Thus, a fixed broadcast range can be assumed for those radio stations. Rather than calculating an area served by each radio station, the processor 12 may simply look for radio stations within that fixed broadcast range as measured from the device's 10 current geographic location.

Alternatively, the processor 12 may actually calculate the area served, for each radio station based on its known transmission power and/or other factors that make up its broadcast range. For example, a radio station may transmit in an essentially Omni-directional manner. However, due to a mountain range or other source of interference/blocking, that radio station's broadcast may be received only at a decreased distance in some directions. Thus, the radio station's broadcast range may not be uniform. In any case, the processor 12 may actually calculate the area served by each radio station and then compare those areas with the device's 10 current geographic location, a route the device 10 is following, or some other user selected location, such as a destination.

The processor 12 may also utilize the user input acquired in step 104 to identify a radio station. For instance, if the user input corresponds to the name of a radio station or a radio station format, the processor 12 may identify radio stations that have broadcast ranges that include the current geographic location of the device 10 and which correspond to the inputted name or format. Similarly, the processor 12 may generate a listing of radio stations that correspond to the provided user input and sort the radio stations within the listing based on their range from the current geographic location of the device 10. In embodiments where the user provides a plurality of inputs, the processor 12 may use any combination of the inputs to identify radio stations.

Step 106 may be repeated continuously or at regular intervals such that the processor 12 is operable to accurately identify radio stations as the current geographic location of the device 10 and/or user input changes. Additionally, through repeated or continuous identification of radio stations corresponding to the current geographic location of the device 10, the processor 12 may also determine when the device 10 enters and exits the broadcast range of a radio station. Thus, as the user travels about, the processor 12 may accurately identify the radio stations whose broadcast range encompasses the current geographic location of the device 10 and/or that correspond to the most recent acquired user input.

In step 108, an indication of the radio station or stations identified in step 106 is presented. For example, the display 20 may present the name, frequency, format, etc, of the radio station or stations identified by the processor 12. In some embodiments, the display 20 may present an ordered listing of radio stations according to their distance from the current geographic location of the device 10, as is shown in the exemplary screen display of FIG. 6. From the ordered listing, the user may easily determine which radio stations are within broadcast range.

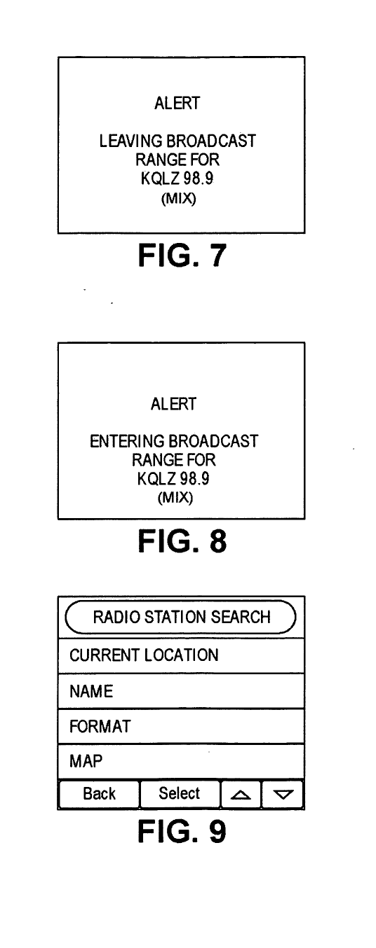

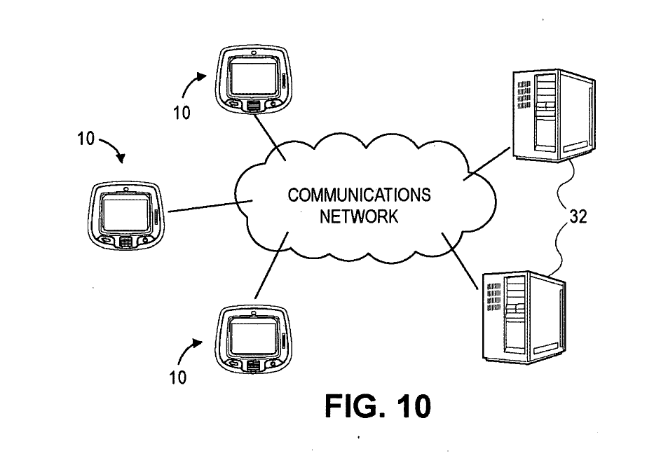

Additionally, the display 20 may present an indication of when the device 10 enters and exits the broadcast range of a radio station as determined by the processor 12 in step 106. For instance, as shown in the exemplary screen display of FIG. 7, the display 20 may issue an alert when the device 10 leaves the broadcast range of a radio station. Similarly, the display 20 may issue an alert when the device 10 enters the broadcast range of a radio station, as is shown in the exemplary screen display of FIG. 8. By issuing alerts and/or notifications regarding the availability of radio stations, the user is dynamically and efficiently informed regarding radio station availability, without necessarily having to function the user interface 18.

As should be appreciated, the alert or notification provided by the display 20 does not necessarily need to be a full-screen alert as shown in the exemplary displays of FIGS. 7 and 8. For instance, the alert or notification provided by the display may be a simple message, such as scrolling messages or a pop-up message, which is presented over or with conventional navigational device content, such as a map showing the current geographic location of the device 10 in relation to nearby thoroughfares.

The alert or notification may simply alert the user or may be more proactive. For example, the alert may ask the user whether he or she would like to tune the radio component 36 to a different station, such as a radio station having a broadcast range the device 10 has just entered. If the user responds affirmatively, the processor 12 may change the frequency of the radio component 36, thereby tuning in that radio station. Alternatively, to ensure the best possible radio signal, the processor may automatically, or semi-automatically tune in the closest radio station meeting constraints prescribed by the user's input.

The alert or notification regarding radio station availability may also be presented by a radio station listing, such as the exemplary screen display provided by FIG. 6. For instance, the display 20 may present the names, frequencies, and formats of radio stations listed according to their distance from the current geographic location of the device 10, and indicate using shading, coloring, or other visual cues which radio stations have broadcast ranges that do not include the current geographic location of the device 10. For instance, the station entitled “KQLZ” in FIG. 6 is shown with a visual cue to indicate that its broadcast range does not include the current geographic location of the device 10. In embodiments where radio station broadcast ranges cannot be specifically determined or where they are otherwise not utilized, the processor 12 may utilize a predetermined or constant broadcast range, such as 150 miles, to indicate the availability of a radio station in a displayed list or alert.

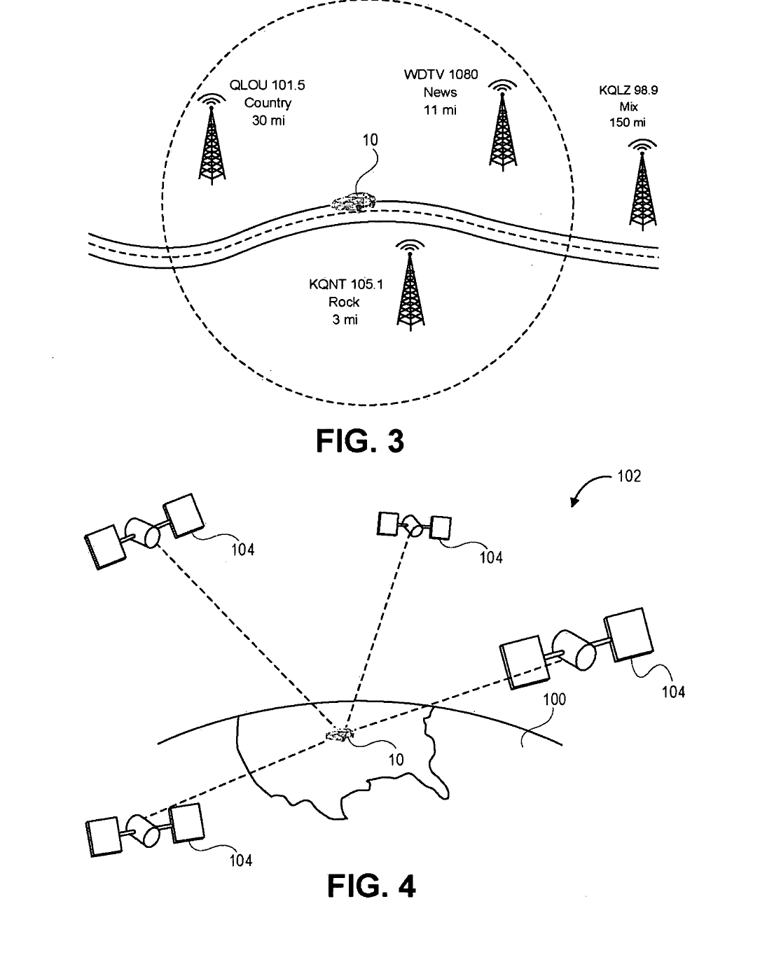

The display 20 may also present a map or other visual geographical representation that indicates the geographic locations of radio stations. In some embodiments, the display 20 may present a map indicating both the geographic locations of radio stations and the current geographic location of the device 10. For instance, the display 20 may present an indication similar to block diagram of FIG. 3, showing the device 10, a predefined range from the device, and radio stations having geographic locations in and out of the predefined range. As should be appreciated, the display 20 may also present an indication of the particular broadcast range of each radio station where such information is available.

Further, as described above in step 104, the user input may correspond to a map area or region such that the display 20 may present a representation of the selected map area in addition to an indication of any radio stations located within the selected map area, including the broadcast range of each radio station, etc. For instance, if the user desires to locate radio stations for listening to in Olathe, Kans., the user may function the user interface 18 to select a region including Olathe from a displayed map, the processor 12 may identify which radio stations have broadcast ranges that include Olathe, and the display 20 may present a map of the selected region including the geographic locations and broadcast ranges of identified radio stations.

As should be appreciated, steps 100-108 discussed above may be employed in addition to conventional navigation device features, such as route calculation, etc., to enable the device 10 to perform generally conventional navigation functions in addition to the functions performed by steps 100-108. Further, the device 10 may utilize the combination of navigation functions and radio station location functions to calculate a route to a destination that ensures the device 10 is within the broadcast ranges of selected radio stations or that ensure that the device 10 is within the broadcast ranges of radio stations having selected formats, such as rock music.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A navigation device comprising:
a location determining component operable to determine a current geographic location of the device;
a memory operable to store data corresponding to a plurality of radio stations and their geographic locations;
a processor coupled with the location determining component and the memory, the processor operable to identify at least one radio station utilizing the current geographic location of the device and the stored data; and
a display coupled with the processor, the display operable to present an indication of the identified radio station.

2. The device of claim 1, wherein the memory is further operable to store data corresponding to broadcast ranges for each radio station.

3. The device of claim 2, wherein the processor is operable to identify at least one radio station having a broadcast range that includes the current geographic location of the device by comparing the current geographic location of the device with at least one of the radio station geographic locations.

4. The device of claim 3, wherein the processor is operable to determine when the current geographic location of the device enters and exits the broadcast range of a radio station.

5. The device of claim 1, wherein the processor is operable to identify a plurality of radio stations utilizing the current geographic location of the device and the stored data and sort the identified radio stations according to their range from the current geographic location.

6. The device of claim 5, wherein the display is operable to present a listing of the sorted radio stations.

7. The device of claim 1, further including a user interface operable to receive a user input, wherein the processor is operable to identify at least one radio station utilizing the user input, the current geographic location of the device, and the stored data.

8. The device of claim 6, wherein the user input corresponds to a radio station format and the processor is operable to identify at least one radio station that corresponds to the provided radio station format and the current geographic location of the device.

9. The device of claim 1, further including a communications element coupled with the processor and operable to access an external source through a communications network, retrieve data corresponding to the radio stations and their geographic locations from the external source, and store the retrieved data within the memory.

10. The device of claim 1, further including a radio component coupled with the processor, the radio component operable to receive Radio Data System (RDS) formatted radio signals including data corresponding to the radio stations and their geographic locations and store data corresponding to the received signals within the memory.

11. A navigation device comprising:
a location determining component operable to determine a current geographic location of the device;
a memory operable to store data corresponding to a plurality of radio stations and related broadcast ranges and geographic locations;
a user interface operable to receive a user input corresponding to a radio station format;
a processor coupled with the location determining component, the memory, and the user interface, the processor operable to—
determine when the current geographic location of the device enters and exits the broadcast range of one or more of the radio stations, and
identify one or more of the radio stations utilizing the current geographic location of the device, the user input, and the stored data and sort the identified radio stations according to their range from the current geographic location; and
a display coupled with the processor, the display operable to present an indication of one or more of the identified radio stations.

12. The device of claim 11, wherein the display is further operable to present an alert when the current geographic location of the device enters and exits the broadcast range of one or more of the radio stations.

13. The device of claim 11, further including a communications element coupled with the processor and operable to access an external source through a communications network, retrieve data corresponding to the radio stations and related geographic locations from the external source, and store the retrieved data within the memory.

14. The device of claim 11, further including a radio component coupled with the processor, the radio component operable to receive Radio Data System (RDS) formatted radio signals including data corresponding to the radio stations and related geographic locations and store data corresponding to the received signals within the memory.

15. A navigation device comprising:
a location determining component operable to determine a current geographic location of the device;
a communications element operable to access an external source and retrieve data corresponding to radio stations and related geographic locations from the external source;
a processor coupled with the location determining component and the communications element, the processor operable to identify at least one radio station utilizing the current geographic location of the device and the retrieved data; and
a display coupled with the processor, the display operable to present an indication of the identified radio station.

16. The device of claim 15, further including a user interface operable to receive a user input, wherein the processor is operable to identify at least one radio station utilizing the user input, the current geographic location of the device, and the retrieved data.

17. The device of claim 15, wherein the communications element includes a radio component coupled with the processor, the radio component being operable to receive Radio Data System (RDS) formatted radio signals including data corresponding to radio stations and related geographic locations.

18. The device of claim 15, wherein the communications element is further operable to retrieve data corresponding to broadcast ranges for each radio station.

19. The device of claim 18, wherein the processor is operable to identify at least one of the radio stations having a broadcast range that includes the current geographic location of the device by comparing the current geographic location of the device with at least one of the radio station geographic locations.

20. The device of claim 19, wherein the processor is operable to determine when the current geographic location of the device enters and exits the broadcast range of at least one of the radio stations.
